(19) United States
(12) Patent Application Publication
(10) Pub. No.: US 2006/0041322 A1
(43) Pub. Date: Feb. 23, 2006

(54) Programmable logic controller satellite interface system and method

(76) Inventor: Ronald H. Naismith, North Andover, MA (US)

Correspondence Address: SQUARE D COMPANY;LEGAL DEPARTMENT IP SECTION, 1415 SOUTH ROSELLE ROAD, PALATINE, IL, 60067, US

(21) Appl. No.: 10/919,914

(22) Filed: Aug. 17, 2004

(51) Int. Cl. G05B 11/01; G05B 19/42

(52) U.S. Cl. 700/18; 700/86; 700/87; 700/23

(57) ABSTRACT

A programmable logic controller is disclosed having a backplane; a local area network interface connected to the backplane, a satellite interface connected to the backplane operatively connectable to a remote computer via a satellite link to receive an automation control program, and an electronic memory for storing the automation control program.

### CROSS-REFERENCE TO RELATED APPLICATIONS

None.

### FEDERALLY SPONSORED RESEARCH OR DEVELOPMENT

None.

### TECHNICAL FIELD

The present invention generally relates to the use of programmable logic controllers and satellite transmission for automation networks. More specifically, the present invention relates to a satellite interface for a programmable logic controller to provide sensitive information for use in an automation network.

### BACKGROUND OF THE INVENTION

A programmable logic controller (PLC) is used to monitor input signals from a variety of input points (i.e., input sensors) that report events and conditions occurring in a controlled process. For example, a PLC can monitor such input conditions as motor speed, temperature, pressure, volumetric flow and the like. A control program is stored in a memory within the PLC to instruct the PLC what actions to take upon encountering particular input signals or conditions. In response to these input signals provided by the input sensors, the PLC derives and generates output signals that are transmitted, via PLC output points, to various output devices, such as actuators and relays, to control the process. For example, as an output signal to speed up or slow down a conveyer, rotate the arm of a robot, open or close a relay, raise or lower temperature, as well as many other possible control functions.

The input and output points referred to above are typically associated with input modules and output modules, respectively. Input modules and output modules are collectively referred to as I/O modules herein. Those skilled in the art alternatively refer to such I/O modules as I/O cards or I/O boards. These I/O modules are typically pluggable into respective slots located on a backplane board provided by the PLC. The slots are coupled together by a main bus that couples any I/O module plugged into the slots to a central processing unit (CPU). The CPU itself can be located on a card that is pluggable into a dedicated slot on the backplane board of the PLC.

In the past, many control systems used a proprietary communications protocol for transmitting data between the PLC, I/O modules, and other PLCs. Today, however, many control system devices use a standard communications protocol such as Ethernet and others.

Sometimes, process parameters such as recipes for processing foods or pharmaceutical are so secret that the access to parameters or the recipe needs to be controlled. However, this is difficult since current PLCs have network interface modules that can be easily sniffed to gain access to the sensitive information.

### SUMMARY OF THE INVENTION

One embodiment of the present invention is directed to a system and method for downloading a control program into a programmable logic controller from a remote computer.

More specifically, in an embodiment, the present invention is directed to a programmable logic controller having a satellite interface. The programmable logic controller includes a backplane; a local area network interface connected to the backplane, a satellite interface connected to the backplane operatively connectable to a remote computer via a satellite link to receive an automation control program, and an electronic memory for storing the automation control program.

In another embodiment of the invention, a system is provided comprising a programmable logic controller having a local area network interface, a satellite interface operatively connected to a remote computer via a satellite link to receive an automation control program, an electronic memory for storing the automation control program, and a central processing unit for executing the control program. A local area network is connected to the programmable logic controller. Further, an input/output module is responsive to commands from the central processing unit.

In yet another embodiment of the invention, a method is provided comprising transmitting an automation control program to a satellite, receiving the automation control program, executing the automation control program, and controlling at least one input/output module based on instructions within the automation control program.

In yet a further embodiment of the invention, a method is provided comprising the step of transmitting an automation control program to a satellite wherein the program contains steps for carrying out at least part of a trade secret. The automation control program is received by a programmable logic controller, executed, and later deleted from the logic controller's memory.

Other features and advantages of the present invention will be apparent from the following specification taken in conjunction with the following drawings.

### BRIEF DESCRIPTION OF THE DRAWINGS

FIG. 1 is a simplified block diagram of an automation control network having a programmable logic controller satellite interface in accordance with the present invention; and,

FIG. 2 is a simplified block diagram depicting additional details of the programmable logic controller satellite interface in FIG. 1.

### DETAILED DESCRIPTION

While this invention is susceptible of embodiments in many different forms, there is shown in the drawings and will herein be described in detail a preferred embodiment of the present invention with the understanding that the present disclosure is to be considered as an exemplification of the principles of the invention and is not intended to limit the broad aspect of the present invention to the embodiment illustrated.

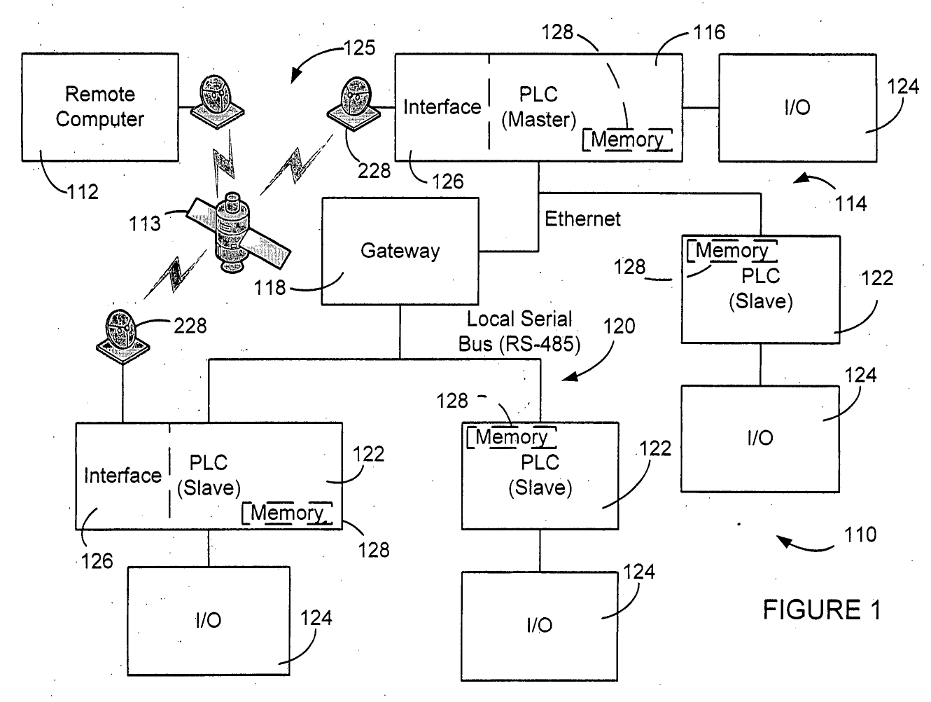

Turning to FIG. 1, a simplified block diagram of an automation control network 110 in accordance with the present invention is depicted. The control network 110 includes, but is not limited to, a remote computer 112, a satellite 113, and an Ethernet based local area network 114 having and at least one master or main programmable logic controller (PLC) 116 connected thereto. Additionally, a gateway 118 is also connected to the local area network 114. The gateway 118 is further connected to a local serial bus 120 with one or more slave devices, such as a slave programmable logic controller (PLC) 122. Each slave device, in turn, is connected to an I/O device or module 124.

Although local area network 114 is described in this embodiment as using an Ethernet communication protocol, it is to be understood that, in other embodiments, the network 114 can use other protocols such as, but not limited to, IEEE 802.3, CAN, CANopen, Profibus, or the like. Furthermore, the network 114 can be wired or wireless.

In FIG. 1, the remote computer 112 is operatively connected to the master or main programmable logic controller 116 via a satellite link 125 between the two devices. As explained in detail further herein, the programmable logic controller 116 can have a separate interface module 126 or, alternative, the interface circuitry can be integrated within other programmable logic controller circuitry.

In operation, the remote computer 112 provides the master or main programmable logic controller 116, with data or programming that represents a desired operation or function to be performed by the control network 110. The data can be based, at least in part, on information received from the input/output (I/O) devices or modules 124 within the control network 110.

As will be understood, using the satellite interface to a PLC to download the recipe or process parameters can eliminate anyone in the facility where the process is performed from needing to have access to the valuable information.

In an embodiment, the remote computer 112 can be located at the corporate offices or corporate R&D facility for downloading the recipe or process parameters in an encrypted or other secure manner. By having the process parameters or recipes only available at a centralized location, the security of these items can be better protected. This may become especially important as companies continue to outsource. For instance, for financial reasons it may be desirable to outsource production to another company, which may even be located in a third world country. Accordingly, the present invention may diminish the possibility of the outsourcing company from having access to the trade secrets of the client company.

As will be appreciated by those having ordinary skill in the art, the I/O device or module 124 connected to a PLC can be, for example, an output sensor and/or actuator. The output sensor can be for a variety of variables including, but not limited to, temperature, flow, pressure, speed, and the like. Accordingly, the output of the I/O device corresponds to the variable being sensed.

In an embodiment, the master or main PLC 116, like the host computer, is operatively connected to the Ethernet local area network 112, supports the Ethernet interface, and runs Modbus/TCP. As will be appreciated by those having skill in the art, both the remote computer 112 and the main PLC 116, can be conventional products that are currently available in the marketplace.

The gateway 118 is operatively connected to the main PLC 116 and at least one of the slave devices 122. Although the gateway is depicted in FIG. 1 as being connected to two slave devices comprising PLCs, it is to be understood that the gateway can be connected to any number of slave devices, and not necessarily PLCs.

In an embodiment, as shown in FIG. 1, the gateway 118 can be connected between the Ethernet based local area network 114 and the local serial bus 120. The gateway 118 provides for protocol conversion between the networks. As such, the gateway 118 intercepts messages from the main PLC 116, on the Ethernet network 114, and converts and distributes these messages to at least one of the slave devices 122 on the local serial bus 120. Similarly, information originated by the slave devices 122 is received by the gateway 118 via the local serial bus 120, and converted and transmitted on the Ethernet network 114 to either the main PLC 116. In an embodiment, the gateway 118 supports Modbus/TCP over Ethernet and the serial interface provided by the gateway is software configurable to support RS-232, RS-422/485, or the like.

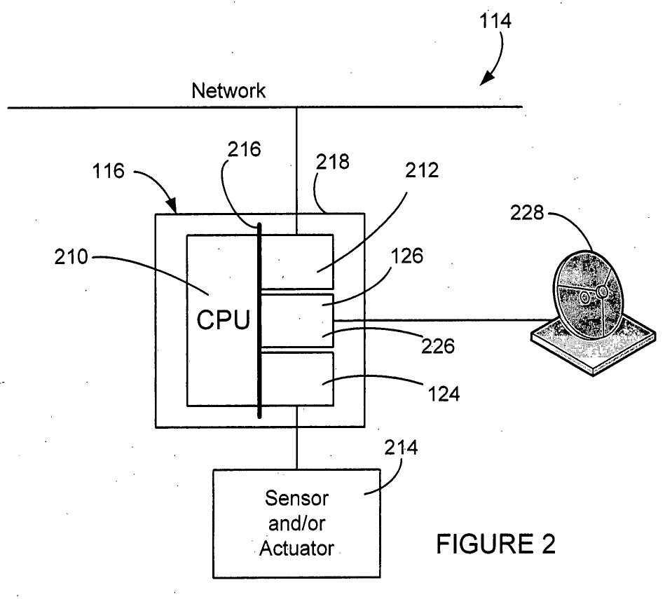

Turning to FIG. 2, a simplified block diagram is provided of the main PLC 116. In an embodiment, the PLC is conventional and includes, but is not necessarily limited to, a processor or CPU 210, a local area network interface comprising an Ethernet interface card 212, a I/O module 124 operative coupled to output sensor and/or actuator 214, and a backplane 216 within a conventional housing 218 suitable for placing the PLC within an industrial environment.

The Ethernet interface card 212 provides the interface to the Ethernet LAN 114 depicted in FIGS. 1 and 2. Likewise, the I/O Module 124 provides the interface to the sensor(s) and/or actuator(s) operatively coupled thereto.

The processor or CPU 210 is a conventional device that provides for executing a real-time multitasking operating system. Moreover, the hardware and software executed by the CPU 210 includes a database or memory 128 (FIG. 1) to store control programs, network node addresses and message indexes, protocol tasks to interface between the buses, and tasks to control the overall data transfer.

The PLC 116 also includes a satellite interface function 126 that can be performed by the CPU 210, or additional hardware/software on the CPU circuit card, or an optional module 226 attached to the backplane 216 and wired to a satellite dish 228. As such, the satellite interface 126 provides for the PLC to communicate with the remote computer via the satellite link 125 (FIG. 1).

In an embodiment, communication over the satellite link can be unidirectional or bidirectional. Currently, commercial satellites have many channels, and surplus bandwidth that can be leased to allow companies to use low cost satellite interface for recipe and/or process parameter downloads.

Turning back to FIG. 1, when a product is to be manufactured in a plant using a trade secret, the manufacturing parameters (i.e., control program comprising computer code for carrying out at least a portion of the trade secret) are downloaded from the remote computer 112 to the memory 128 of the PLC 116, via the satellite link 125. Next, the product would be run through the plant. After the product is run, the remote computer, via the satellite link 125, can erase the secret process parameters and/or recipe (i.e., control program) from the PLC memory 128.

In another embodiment of the invention, the remote computer 112 can download data into the memory of a slave PLC 122 having a satellite interface. As such, data or programs specific to the slave PLC can be downloaded directly from the remote computer 112.

In operation, the gateway 118 polls the specified slave memory addresses 126 of each slave device and, if the slave memory addresses have been written with new data, the new data is written into the memory 128 of the main PLC 116 via the gateway.

While the specific embodiments have been illustrated and described, numerous modifications come to mind without significantly departing from the spirit of the invention, and the scope of protection is only limited by the scope of the accompanying Claims.

What is claimed is:

1. A programmable logic controller comprising:
a backplane;
a local area network interface connected to the backplane;
a satellite interface connected to the backplane operatively connectable to a remote computer via a satellite link to receive an automation control program;
an electronic memory for storing the automation control program.

2. The programmable logic controller of claim 1 wherein an input/output module is connected to the backplane.

3. The programmable logic controller of claim 2 wherein a sensor or actuator is operatively connected to the input/output module.

4. The programmable logic controller of claim 1 wherein the local area network interface supports Ethernet

5. The programmable logic controller of claim 1 wherein the satellite interface is operatively connected to a satellite dish.

6. The programmable logic controller of claim 1 wherein the programmable logic controller is not a slave device.

7. The programmable logic controller of claim 1 wherein the programmable logic controller is a slave device.

8. The programmable logic controller of claim 1 wherein the backplane, local area network interface, and satellite interface are contained in a housing suitable for mounting in an industrial environment.

9. A system comprising:
a programmable logic controller comprising a local area network interface, a satellite interface operatively connected to a remote computer via a satellite link to receive an automation control program, an electronic memory for storing the automation control program, and a central processing unit for executing the control program;
a local area network connected to the programmable logic controller;
an input/output module responsive to commands from the central processing unit.

10. The system of claim 9 where the programmable logic controller is not a slave device.

11. The system of claim 9 wherein the programmable logic controller is a slave device.

12. The system of claim 9 wherein the automation control program is encrypted

13. The system of claim 9 wherein the satellite interface is a module connected to a backplane within the programmable logic controller.

14. The system of claim 9 wherein the satellite interface is integrated into electronic circuitry associated with the central processing unit.

15. The system of claim 9 wherein the programmable logic controller is operatively connected to another programmable logic controller.

16. The system of claim 9 wherein coupled between the programmable logic controller and the input/output module is another programmable logic controller.

17. A method comprising the steps of:
transmitting an automation control program to a satellite;
receiving the automation control program by a programmable logic controller in an automation network;
executing the automation control program; and,
controlling at least one input/output module based on instructions within the automation control program.

18. The method of claim 17 further comprising the step of encrypting the automation control program.

19. The method of claim 17 further comprising the step of storing the automation control program within a programmable logic controller memory.

20. The method of claim 19 further comprising the step of erasing the automation control program from the programmable logic controller memory.

21. The method of claim 19 wherein the automation control program contains computer code for carrying out at least a portion of a trade secret.
